(19) United States
(12) Patent Application Publication
(10) Pub. No.: US 2018/0066948 A1
(43) Pub. Date: Mar. 8, 2018

(54) ALIGNMENT OF VISUAL INDICATORS ON NAVIGATIONAL MAPS

(71) Applicant: GOOGLE INC., Mountain View, CA (US)

(72) Inventor: Zhou Bailiang, Balgowlah (AU)

(21) Appl. No.: 14/957,425

(22) Filed: Dec. 2, 2015

Related U.S. Application Data
(60) Provisional application No. 62/086,546, filed on Dec. 2, 2014.

(51) Int. Cl. G01C 21/36

(52) U.S. Cl. CPC G01C 21/367; G01C 21/3673

(57) ABSTRACT

A computer-implemented method for aligning map elements for display along a route within a digital map is presented. The method may receive a request for route data including an origin and a destination and determine route data defining a route navigating from the origin to the destination. The method may also determine a plurality of map elements that each intersect the route at one or more points along the route, each of the plurality of map elements having a corresponding visual identifier displayed on the map, align the corresponding visual identifiers adjacent to the route and transmit the aligned corresponding visual identifiers for display on the digital map.

### FIELD OF THE DISCLOSURE

The present disclosure relates to displaying routes on a map rendered by a mapping application running on a computing device and more specifically to a system and a method for aligning visual indicators of map elements.

### BACKGROUND

This disclosure relates to the placement of visual indicators on digital mapping systems. For example, because the street labels are often not aligned with the route, a user's eyes must follow in a undefined or irregular pattern to determine which streets are being passed on the route. Reading the street labels is especially challenging when the user is driving a vehicle, because the user must split her concentration between reading the map/directions and driving.

### SUMMARY

Systems and methods for alignment of visual indicators on navigational maps determine that map elements intersect a route and render aligned visual indications of the intersecting map elements in visual proximity to the route. For example, a street label may be a visual indicator corresponding to a map element such as a street. Accordingly, street labels corresponding to streets that intersect the route may be emphasized, such as by aligning the street labels adjacent to the route. Street labels aligned to the route may guide the user's eye in a clear and concise manner so that the user may easily read the relevant street labels when glancing at the route. In some embodiments, other map features, such as point-of-interest (POI) markers, may be aligned to the route as well.

More particularly, an example implementation of the techniques of the present disclosure is a computer-implemented method for aligning map elements for display along a route within a digital map. The method includes receiving a request for route data via a computer network from a client computing device, wherein the request includes an origin and a destination. The method also includes determining route data in response to receiving the request for route data, the route data defining a route navigating from the origin to the destination and determining a plurality of map elements that each intersect the route at one or more points along the route, each of the plurality of map elements having a corresponding visual identifier displayed on the map. The method further includes aligning the corresponding visual identifiers adjacent to the route and transmitting the aligned corresponding visual identifiers for display on the digital map.

Yet another example implementation of the techniques of the present disclosure is a computer-implemented method for aligning map elements for display along a route within a digital map. The method includes transmitting, via a computer network, a request for route data, wherein the request includes an origin and a destination. The method also includes receiving, via the computer network, route data in response to the request for route data, the route data defining a route navigating from the origin to the destination and determining a plurality of map elements that each intersect the route at one or more points along the route, each of the plurality of map elements having a corresponding visual identifier displayed on the map. The method also includes aligning the corresponding visual identifiers adjacent to the route and displaying the aligned corresponding visual identifiers on the digital map.

Yet another example implementation of the techniques of the present disclosure is a computer device for aligning map elements for display along a route within a digital map, the computer device comprising one or more processors and one or more memories coupled to the one or more processors, the one or more memories including non-transitory computer executable instructions stored therein. When executed by the one or more processors, the non-transitory computer executable instructions stored therein cause the one or more processors to receive, via a computer network, a request for route data from a client computing device, wherein the request includes an origin and a destination. The non-transitory computer executable instructions stored therein also cause the one or more processors to determine route data in response to receiving the request for route data, the route data defining a route navigating from the origin to the destination and determine a plurality of map elements that each intersect the route at one or more points along the route, each of the plurality of map elements having a corresponding visual identifier displayed on the map. The non-transitory computer executable instructions stored therein further cause the one or more processors to align the corresponding visual identifiers adjacent to the route and transmit the aligned corresponding visual identifiers for display on the digital map.

Still another implementation of these techniques is computer readable storage medium comprising non-transitory computer readable instructions stored thereon for aligning map elements for display along a route within a digital map. When executed by one or more processors, the instructions cause the one or more processors to receive, via a computer network, a request for route data from a client computing device, wherein the request includes an origin and a destination and determine route data in response to receiving the request for route data, the route data defining a route navigating from the origin to the destination. The instructions further cause the one or more processors to determine a plurality of map elements that each intersect the route at one or more points along the route, each of the plurality of map elements having a corresponding visual identifier displayed on the map. The instructions still further cause the one or more processors to align the corresponding visual identifiers adjacent to the route and transmit the aligned corresponding visual identifiers for display on the digital map.

Another example implementation of the techniques of the present disclosure is another computer device for aligning map elements for display along a route within a digital map. The computer device includes a means for receiving a request for route data via a computer network from a client computing device, wherein the request includes an origin and a destination. The computer device also includes a means for determining route data in response to receiving the request for route data, the route data defining a route navigating from the origin to the destination and a means for determining a plurality of map elements that each intersect the route at one or more points along the route, each of the plurality of map elements having a corresponding visual identifier displayed on the map. The computer device further includes a means for aligning the corresponding visual identifiers adjacent to the route and a means for transmitting the aligned corresponding visual identifiers for display on the digital map.

### BRIEF DESCRIPTION OF THE DRAWINGS

FIG. 1 is a high-level block diagram of a system for alignment of visual indicators on navigational maps;

FIG. 2A is an illustration of an exemplary navigational map rendered without emphasized visual indicators;

FIG. 2B is an illustration of an exemplary navigational map rendered with emphasized visual indicators;

FIG. 2C is an illustration of another exemplary navigational map rendered with aligned visual indicators;

FIG. 3 is an exemplary flow chart of one method to flag map elements for flexible placement on a navigational map according to an embodiment described herein;

FIG. 4A is an exemplary data structure for a route request;

FIG. 4B is an exemplary data structure for a route data;

FIG. 5 is an exemplary flow chart of one method to align visual indicators corresponding to flexible map elements to a reference point according to an embodiment described herein;

FIG. 6 is an exemplary flow chart of one method to determine if a map element falls within a threshold radius according to an embodiment described herein; and

FIG. 7 is high-level block diagram of a computing environment that implements a system and method for alignment of visual indicators on navigational maps.

The figures depict embodiments of the present invention for purposes of illustration only. One skilled in the art will readily recognize from the following discussion that alternate embodiments of the structures and methods illustrated herein may be employed without departing from the principles of the invention described herein.

### DETAILED DESCRIPTION

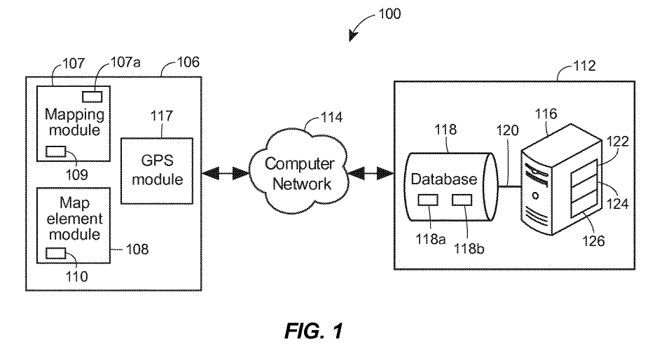

FIG. 1 is a high-level block diagram that illustrates an example system 100 for aligning visual indicators on navigational maps. The system 100 may include a computing device 106 such as a personal computer, smart phone, tablet computer, smart watch, head mounted display (HMD), or other computing device capable of executing the various modules, instructions, etc., described herein. The computing device 106 may execute various modules, such as a mapping module 107 and map element module 108 that allow the device 106 to receive, analyze, align and/or display map data 108 including route data 109 and map element data 110 for display on a computing device 106.

More specifically, the mapping module 107 may include computer-executable instructions to allow the mapping module 107 to render a digital representation of a user's current geographic location or any other geographic location in a display component of the computing device 106. As part of the rendering process (e.g., when the user executes the mapping module 107, conducts a geographic location search using the mapping module 107, etc.), the mapping module 107 may execute instructions to display a mapping interface 107a including the map data 108. The mapping interface 107a may allow a user to cause the device 106 to render various digital representations of geographic locations using map data 108, map element data 110, etc.

The map element module 108 or various other modules of the computing device 106 may include computer-executable instructions to determine map element data 110 for display on the map. Map element data may define geographic locations for display on the map. For example, the map element data may define nearby streets, POIs, highways, bodies of water, etc. In some embodiments, the computing device 106 may store map element data 110 from a variety of other modules executing on the computing device 106 or in communication with the computing device 106 (e.g., a web browser, a user activity tracking module, a trip planning module, an email module, etc.).

In some embodiments, the map element module 108 at the client device 106 may receive, send, and analyze map element data 110 that is displayed at the computing device 106 using the mapping module 107. In some embodiments, the module 108 includes instructions to analyze map element data 110 to determine one or more map elements that each intersect the route at different points. Analysis of the map element data 110 by the map element module 108 at the client mobile computing device 106 may include computer-executable instructions to determine location data that the module 108 may send to the mapping system 112.

The computing device 106 may communicate with a mapping system 112, through the Internet 114 or other type of network (e.g., LAN, a MAN, a WAN, a mobile, a wired or wireless network, a private network, or a virtual private network, etc.). The mapping module may send a request for data to a mapping server 116. The request may also include location data retrieved or received from a GPS module 117 of the computing device 106.

The mapping system 112 may include a mapping server 116 and a database 118 connected via a communication link 120. The mapping server 116 may include a route module 122, a map element module 124 and an emphasis module 126. The route module 122 may receive, send, calculate and/or analyze map data requests from the computing device 106 and/or map data 118a for determining route data 118b that may be transmitted to the client computing device 106. Route module 122 may include computer-executable instructions to analyze the map data 118a, route data 118b and/or other data stored in the data repositories.

The map element module 124 may include computer-executable instructions to determine map element data 110 for display on the map. Map element data 110 may define geographic locations for display on the map. For example, the map element data 110 may define nearby streets, POIs, highways, bodies of water, etc. In some embodiments, the map element module 124 includes instructions to analyze map element data 110 to determine one or more map elements that each intersect the route at different points. The emphasis module 126 includes instructions to emphasize map elements defined by map element data 110 for display on a digital map. Examples of emphasis include alignment of visual indicators corresponding to the map elements, bolding of the corresponding visual indicators, etc.

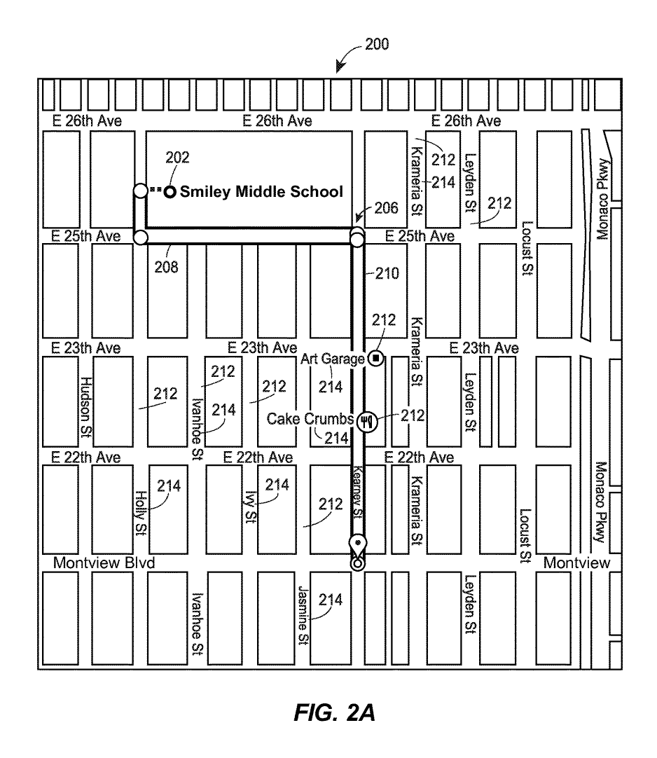

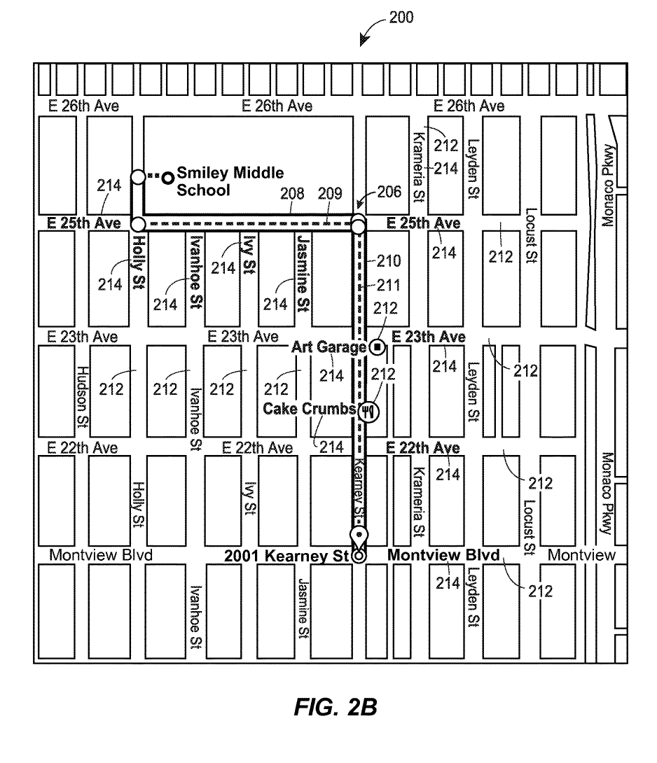

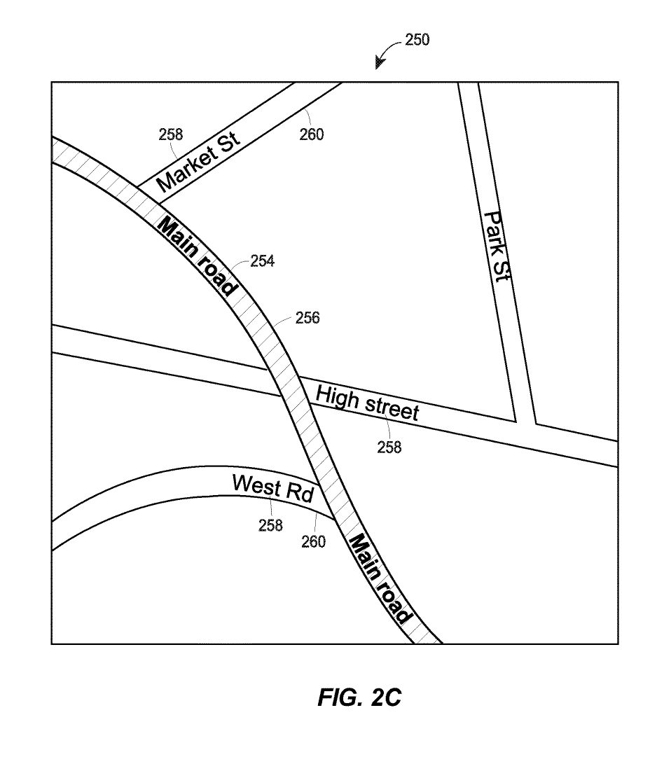

Turning now to FIGS. 2A and 2B, an exemplary map 200 is illustrated. The map 200 may be rendered by a mapping interface 107a that includes instructions stored in a memory or computer-readable medium and executed by a computing device (e.g., client computing device 106).

As illustrated in FIG. 2A, the map may include an origin point 202, a destination point 204, and a route 206. The route 206 may include a first route segment 208 and a second route segment 210. Although the map 200 only includes two route segments, those skilled in the art will appreciate that the route 206 may have any number of route segments. The map 200 also includes a plurality of map elements 212 and each map element may have a corresponding visual indicator 214. For example, a map element 212 may be a street and the corresponding visual indicator 214 may be a street label identifying that street (i.e., “Ivy St.”). As another example, the map element 212 may be a point of interest (POI) and corresponding visual indicator 214 may be a POI label identifying the POI (i.e., “Art Garage”). Those skilled in the art will appreciate that the map 200 may include additional types of map elements as well (e.g., a body of water including a name or other identifying information, a park or forest with identifying information, etc.). FIG. 2A illustrates the exemplary map without emphasized visual indicators and without visual indicators aligned with the route 206 (i.e., rendering or otherwise displaying the visual indicators in a line corresponding to the same shape as the route or route segment, here, a straight line).

Turning now to FIG. 2B, visual indicators 214 of map elements 212 that intersect the route 206 may be emphasized when displayed on the map 200 along a first reference point 209 of the first route segment 208 and a second reference point 211 of the second route segment 210. Generally speaking, the reference point defines the location to which the visual indicators will be aligned. For example, in FIG. 2B, the reference point is illustrated as the longitudinal axis of the route. However, those of ordinary skill in the art can appreciate that numerous other reference points can be used, such as the route and/or route segment, a line that lays parallel to the route. etc. In some embodiments, different portions of the route may have different reference points.

One form of emphasis may be the placement of the visual indicators 214 on the map. For example, visual indicators 214, such as street labels, may be aligned along the first reference point 209 of the first route segment 208 and a second reference point 211 of the second route segment 210. Moreover, each street label may be displayed in an expected position in relation to the route 206. As illustrated in FIG. 2B, each visual indicator 214 that intersects the route 206 may also be spaced from the reference point 209, 211 in a way that makes it easy for a user's eyes to follow from one visual indicator to the next while the user's eyes also follow the route 206. Aligning the visual indicators 214 in this manner may guide the user's eye in a clear and concise manner so that the user can easily read the relevant visual indicators 214 when glancing at the route 206. In some embodiments, visual indicators 214 (e.g., a street name) of a map element 212 (e.g., a street) that intersect the route 206 are positioned an equal distance from the point at which the map element 212 intersects the route 206. The map elements 212 that intersect the route 206 may be aligned evenly adjacent to the route 206, such that the alignment is the same for each element when there are two or more elements that intersect the route.

In some embodiments, the visual indicators 214 of map elements 212 that intersect the route 206 are aligned along a line parallel the longitudinal axis of the route 206. The longitudinal axis may be, for example, the lengthwise axis of the route 206, a line extending in the direction of the length of the route 206, etc. In some embodiments, the map elements 212 that intersect the route 206 may be aligned evenly adjacent to or against the longitudinal axis of the route 206.

In addition to placement of the visual indicators 214, other forms of emphasis include the way the visual indicator is rendered, styles applied to the visual indicator, etc. For example, instead of or in addition to aligning the visual indicators, the visual indicator may be bolded, italicized, a certain color, etc. The emphasis as described herein may also be triggered by one or more events related to execution of the mapping module 107 and rendering of the route 206 at the client computing device 106. For example, the computing device 106 may execute an instruction to emphasize each indicator 214 as the module 107 detects that the device 106 is within a threshold proximity to a feature that intersects the route 206. In other words, as the user travels along the route 206, each indicator 214 may be emphasized as the user travels past each feature corresponding to the indicator. Such emphasis may occur while the user is within a threshold proximity to the feature along the route 206, and may then be de-emphasized as the user travels outside of the threshold proximity to the route 206. In other embodiments, the mapping system 112 may determine how and when an indicator 214 is emphasized at the client computing device 106.

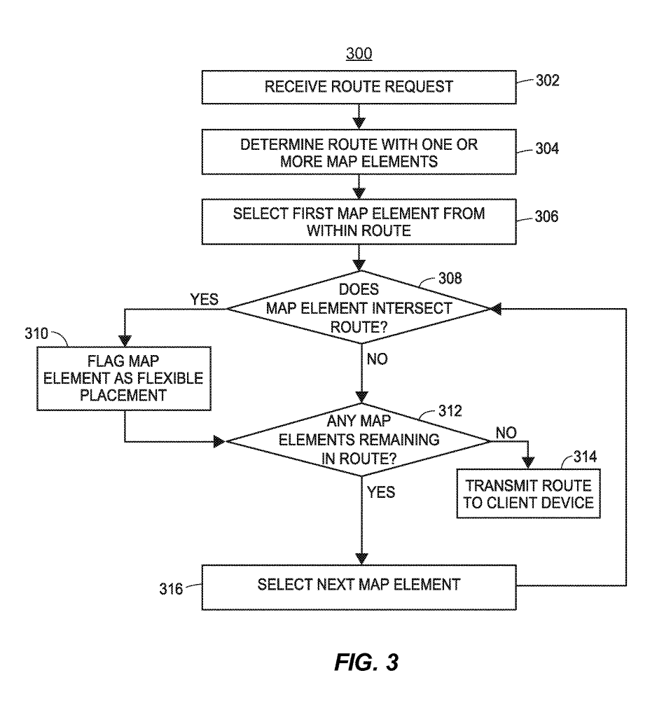

The map 200 of FIGS. 2A and 2B will be described in more detail in reference to the method 300 depicted in FIG. 3. Turning now to FIG. 3, a flow chart depicts an exemplary method 300 for determining map elements that intersect a route 206. At block 302, the processor of a mapping server (such as the mapping server 116 illustrated in FIG. 1) may receive a route request from a client device (such as the client device 106 illustrated in FIG. 1).

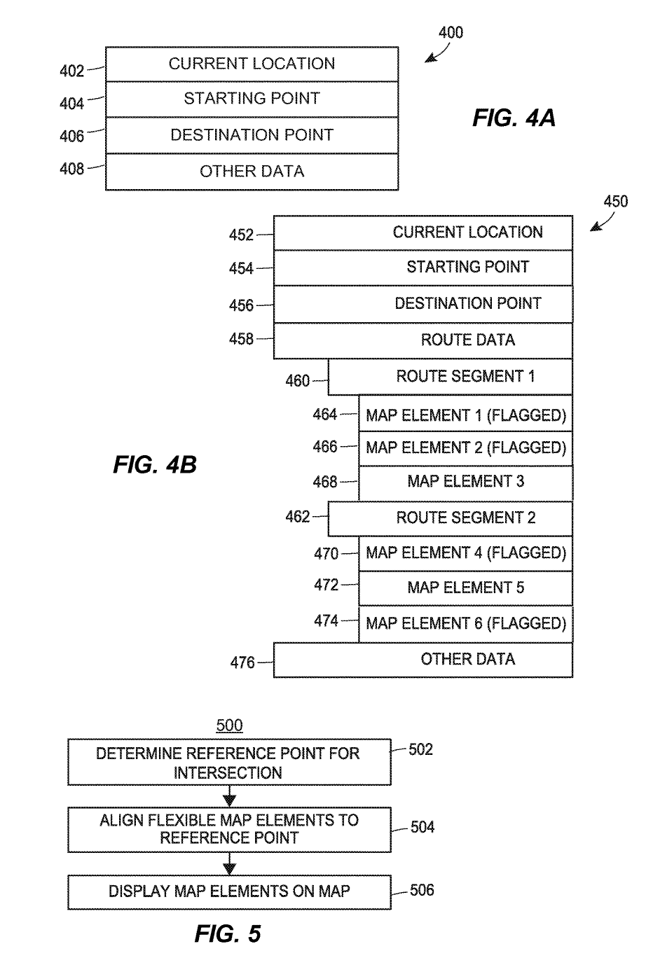

Turning briefly to FIG. 4A, an exemplary route request 400 may correspond to a data structure including a single electronic message or a series of electronic messages, depending on the scenario and/or embodiment. The request may include any data to facilitate the system 112 determining various data points corresponding to geographic locations in order to render the various maps and map elements, as herein described. While the request 400 of FIG. 4A illustrates several types of data, the systems and methods described herein may use all or only some of the types of data. In some embodiments, the request 400 may include current location data 402, origin data 404, destination data 406, and other data 408. The current location data 402 may be retrieved or received from a GPS module 119 of the computing device 106. The current location data 402 may include coordinates corresponding to a geographic location that represents a user's current location. The origin data 404 may define the starting location of the user's route. In some embodiments the origin data 404 may define the same location as the current location data 402. The destination data 406 may define the destination desired by the user. The other data 408 may define an account identifier, current time, etc. The current location data 402, origin data 404 and destination data 406 may include one or more of a city name, an address, an airport code, global positioning system coordinates, etc.

Returning to FIG. 3, at block 304, a processor of the mapping server 116 may execute an instruction to retrieve route data defining a route from the origin point to the destination point (such as the origin point specified in the origin data 404 and the destination point identified in the destination point data 406). Each route may include one or more route segments. Each route may also include a group of one or more map elements that will be displayed on the map. Each map element may correspond to or be represented by a visual indicator. As discussed above, the map elements may include nearby streets, POIs, highways, bodies of water, etc. Although numerous map elements may be displayed on a map, in some embodiments, only a portion of map elements may intersect the route. The map elements that intersect the route may be of particular relevance of the user, as they may be used to guide the user along the route. Accordingly, it may be beneficial to add an emphasis to the visual indicators corresponding to the map elements that intersect the route.

At block 306, the processor may execute an instruction to select the first map element from the group of map elements to be displayed on the map and at block 308 the processor may execute an instruction to determine if the selected map element intersects the route defined by the route data. If the processor executing the instruction determines that the map element does not interest the route (NO Branch of block 308), at block 312 the processor may execute an instruction to determine if any map elements remain in the group. If the processor executing the instruction determines that the map element does intersect the route (YES Branch of block 308), at block 310 the processor may flag the map element as a flexible placement map element. As will be discussed later, visual indicators for map elements that are flagged as flexible placement, may be further emphasized when being rendered on the map. In some embodiments, block 310 includes an instruction to flag map elements for flexible placement that are a particular type. For example, the block 310 may include an instruction to flag only those elements that are a label (i.e., visual indicator) for another map element that intersects the route, as determined by block 308.

Thereafter, at block 312, the processor may further execute an instruction to determine if any map elements remain in the group. If the processor executing the instruction determines that no map elements remain in the group (NO branch of block 312), at block 314, the processor may execute an instruction to transmit the route to the client device. If the processor executing the instruction determines that one or more map elements remain in the route (YES branch of block 312), at block 316 the processor may execute an instruction to select the next map element and at block 308, the processor may execute an instruction to determine if the map element intersects the route. Accordingly, the processor may continue to execute one or more steps of the method 300 until there are no more map elements left in the group. If the processor executing the instruction determines that no map elements remain in the group, at block 314, the processor may execute an instruction to transmit the route to the client device.

FIG. 4B illustrates a data structure corresponding to exemplary route data structure 450 transmitted to the client device. The data structure may include a single electronic message or a series of electronic messages, depending on the scenario and/or embodiment. While the data structure 450 of FIG. 4B illustrates several types of data, the systems and methods described herein may use all or only some of the types of data. In some embodiments, the request 400 may include current location data 452, origin data 454, destination point data 456, and route data 458. The current location data 452 may include coordinates corresponding to a geographic location that represents a user's current location. The geographic location may include one or more of a city name, an address, an airport code, global positioning system coordinates, etc. The origin or start point data 454 may be the starting location of the user's route. In some embodiments the origin 454 may be the same location as the current location data 452. The destination point 456, may be the destination desired by the user. The route data 458 may define a route directing a user from the origin 454 to the destination point 456. The route data 458 may include one or more route segments and each route segment may include one or more map elements. One or more of the map elements may be flagged as having a flexible position. As discussed above, map elements flagged as flexible position may be rendered by the client computing device with an emphasis when displayed on the map. For example, the exemplary route data 458 may include a route segment 460 and a route segment 462. The route segment 460 may further include a map element 464, a map element 466 and a map element 468. The route segment 462 may further include a map element 470, a map element 472 and a map element 474. The map element 464, the map element 466, the map element 468, the map element 470 and the map element 474 may be flagged as flexible placement. The other data 476 may include an account identifier, current time, etc.

Turning again to FIG. 2B, the map 200 depicts a map route and a plurality of map elements including streets, POIs, etc. A processor executing one or more instructions of the method 300 may determine which of the map elements intersect with the map route and align the visual indicators corresponding to the map elements intersecting with the map route using the route data 450, described above. For example, in the exemplary map 200 depicted in FIG. 2B, map elements that intersect the route may include “Holly Street,” “Ivanhoe Street,” “Ivy Street,” “Jasmine Street,” “E 25th Ave,” “E. 23rd Ave,” “E 22nd Ave” and “Montview Blvd.” As depicted in FIG. 2B, the visual indicators 214 corresponding to the intersecting map elements 212 are rendered by the client computing device using the route data 450 aligned adjacent to the route 206. As discussed above, each visual indicators 214 of a map element 212 that intersects the route 206 may be positioned an equal distance from the point at which the map element 212 intersects the route 206. In some embodiments, the visual indicators 214 of map elements 212 that intersect the route 206 are aligned along a line parallel the longitudinal axis. In some embodiments, the visual indicators may be further emphasized, such as by bolding the text of the visual indicator, etc. Turning briefly to FIG. 2C, a map 250 is illustrated with a route 254 including a curved route segment 256. The visual indicators 258 corresponding to the map elements 212 intersecting the curved route segment 256 may be rendered by instructions executing on the client computing device to be visually adjacent to the route. In FIG. 2C, the reference point is the curved route segment 256, and the visual indicators 258 are rendered along the curve route segment 256.

Turning now to FIG. 5, a flow chart depicts an exemplary method 500 for aligning visual indicators corresponding to map elements on a map using the data of the exemplary route data structure 450. At block 502, a processor may execute an instruction to determine a reference point for the intersection of map elements. As described above, the reference point defines the location to which the visual indicators will be aligned. For example, the reference point may be the route and/or route segment, the longitudinal axis of the route, a line that lays parallel to the route. etc. Of course these are example reference points, and those of ordinary skill in the art will appreciate that other types and numbers of reference points can be used. In some embodiments, different portions of the route may have different reference points.

For example, turning again to FIG. 2B, the route 206 on the map 200 includes a first 208 and a second 210 route segment. The processor may execute an instruction to determine a reference point for each route segment. For example, the longitudinal axis of the first route segment 208 may serve as the reference point for the first route segment 208 and the longitudinal axis of the second route segment 210 may serve as the reference point for the second route segment 210. In some embodiments, the route and/or route segment itself may be the reference point.

At block 504, the processor may execute an instruction to align map elements flagged as flexible placement to the reference point. For example, if the reference point is the longitudinal axis of the route, the processor may execute an instruction to align the corresponding visual identifiers adjacent to the longitudinal axis of the route. As another example, if the reference point is a line that lays parallel to the route, the processor may execute an instruction to align the visual indicators corresponding to the intersected elements to lay along a line parallel to the route. As yet another example, if the reference point is the route and/or route segment, the processor may execute an instruction to align the visual indicators along the route/route segment and/or align the visual identifiers along the lengthwise edge of a first route segment of the route. In some embodiments, the map elements 212 that intersect the route 206 may be aligned evenly adjacent to the route 206. In this manner, the alignment is the same for each element when there are two or more elements that intersect the route. At block 506, the processor may execute an instruction to display the visual indicators corresponding to the map element on the map.

As discussed above, the visual indicators 214 of map elements 212 that intersect the route 206 may be positioned such that each visual indicator 214 is positioned an equal distance from the point at which the map element 212 intersects the route 206. In some embodiments, the visual indicators may be further emphasized, such as by bolding the text of the visual indicator, etc.

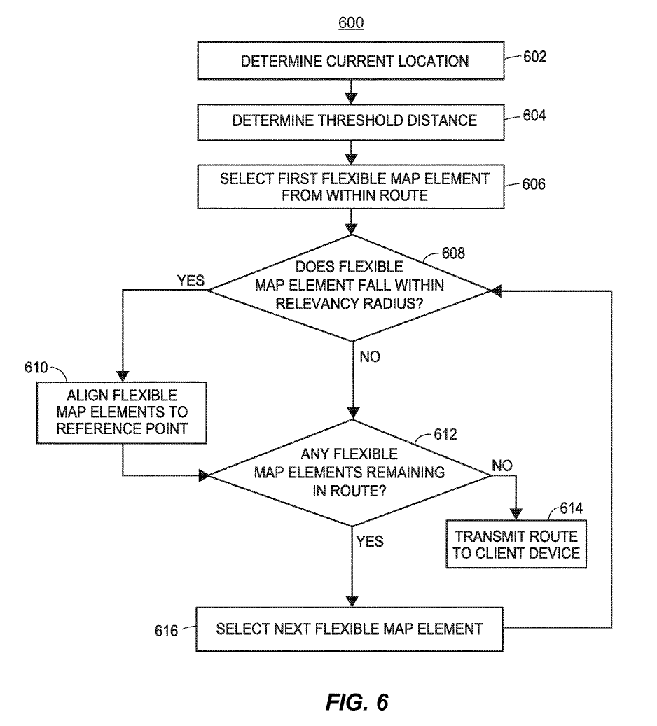

In some embodiments, map elements that intersect with the route may be emphasized when within a threshold distance of the user's location. Accordingly, the emphasis may dynamically change as the user approaches and/or departs certain areas. Turning now to FIG. 6, a flow chart depicts an exemplary method 600 for dynamically emphasizing map elements on a map. At block 602, the processor may execute an instruction to determine a user's current location. As discussed above, the user's location may be received and/or retrieved from a GPS module of a client device. In some embodiments, the user current location may also be defined in the route request data structure, such as the data structure 400 illustrated in FIG. 4A or the route data structure of FIG. 4B. At block 604, the processor may execute an instruction to determine a threshold value for emphasis. The threshold value may be a distance, a time, a weather condition, etc. The threshold value may be set by user preference, developer preference, system preference, etc.

As discussed above, each route may also include a group of one or map elements that will be displayed on the map. The map elements may include, for example, nearby streets, POIs, highways, bodies of water, etc. At block 606, the processor may execute an instruction to select a first map element flagged as flexible placement from the group of map elements for the route. At block 608, the processor may execute an instruction to determine if the selected map element meets the threshold value. For example, the threshold value may be a certain distance between the user's current location and a particular map element. If the processor executing the instruction determines that the selected map element does not meet the threshold value (NO branch of block 608), at block 610, the processor may execute an instruction to determine if any additional map elements flagged as flexible remain in the group. For example, the processor may execute an instruction to determine if the user current location is within a threshold distance to a particular map element.

If the processor executing the instruction determines that the selected map element does meet the threshold value (YES branch of block 608), at block 610, the processor may execute an instruction to emphasize the visual indicator corresponding to the map element. For example, the processor may execute an instruction to align the visual indicator along a reference point as described above in reference to the method 300 illustrated in FIG. 3.

At block 612, the processor may execute an instruction to determine if any additional map elements flagged as flexible remain in the group. If the processor executing the instruction determines that no flexible map elements remain in the group, (NO branch of block 612), then at block 614 the processor may execute an instruction to transmit the route to the client device. If the processor executing the instruction determines that no flexible map elements remain in the group, (YES branch of block 612), then at block 616, the processor may execute an instruction to select the next map element flagged as flexible placement from the group and at block 608, the processor may execute an instruction to determine if the selected map element meets the threshold value. Accordingly, the processor may continue to execute one or more steps of the method 600 may continue until there are no more map elements left in the group. If the processor executing the instruction determines that no map elements remain in the group, at block 614, the processor may execute an instruction to transmit the route to the client device.

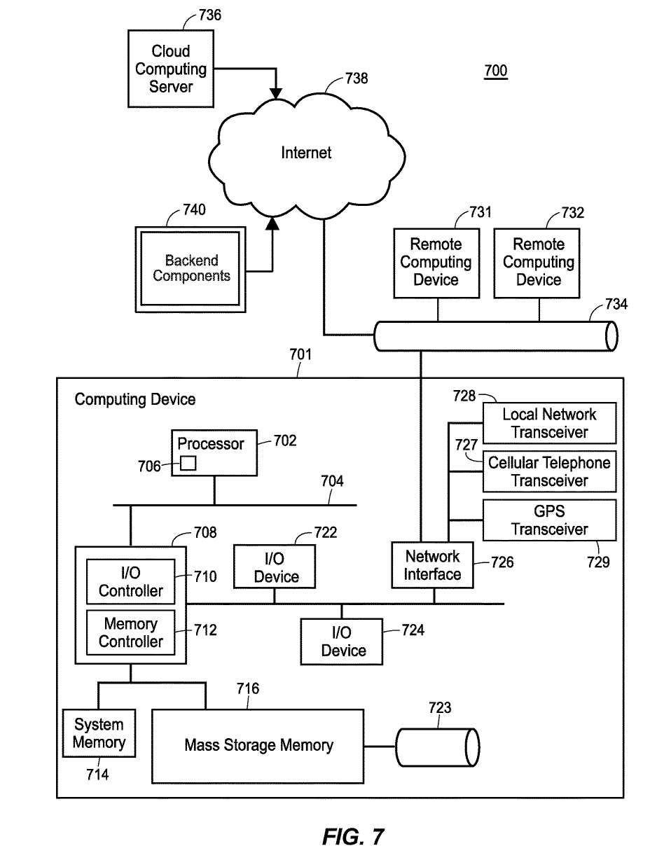

FIG. 7 is a high-level block diagram of an example computing environment for a mapping system 700 having a computing device 701 that may be used to implement the system 100 for alignment of visual indicators on navigational maps. The computing device 701 may include a mobile device (e.g., a cellular phone, a tablet computer, a smart watch, a head mounted display, a Wi-Fi-enabled device or other personal computing device capable of wireless or wired communication), a thin client, or other known type of computing device. As will be recognized by one skilled in the art, in light of the disclosure and teachings herein, other types of computing devices can be used that have different architectures. Processor systems similar or identical to the example mobile mapping system 700 may be used to implement and execute the example system of FIG. 1, the method 300 of FIG. 3, the method 500 of FIG. 5, the method 600 of FIG. 6, analyze the data structure 400 of FIG. 4A the data structure 450 of FIG. 4B, etc. Although the example mobile mapping system 500 is described below as including a plurality of peripherals, interfaces, chips, memories, etc., one or more of those elements may be omitted from other example processor systems used to implement and execute the example system 100 for alignment of visual indicators on navigational maps. Also, other components may be added.

As shown in FIG. 7, the computing device 701 includes a processor 702 that is coupled to an interconnection bus 704. The processor 702 includes a register set or register space 706, which is depicted in FIG. 7 as being entirely on-chip, but which could alternatively be located entirely or partially off-chip and directly coupled to the processor 702 via dedicated electrical connections and/or via the interconnection bus 704. The processor 702 may be any suitable processor, processing unit or microprocessor. Although not shown in FIG. 7, the computing device 701 may be a multi-processor device and, thus, may include one or more additional processors that are identical or similar to the processor 702 and that are communicatively coupled to the interconnection bus 704.

The processor 702 of FIG. 7 is coupled to a chipset 708, which includes a memory controller 712 and a peripheral input/output (I/O) controller 710. As is well known, a chipset typically provides I/O and memory management functions as well as a plurality of general purpose and/or special purpose registers, timers, etc. that are accessible or used by one or more processors coupled to the chipset 708. The memory controller 712 performs functions that enable the processor 702 (or processors if there are multiple processors) to access a system memory 714 and a mass storage memory 716.

The system memory 714 may include any desired type of volatile and/or non-volatile memory such as, for example, static random access memory (SRAM), dynamic random access memory (DRAM), flash memory, read-only memory (ROM), etc. The mass storage memory 816 may include any desired type of mass storage device. For example, if the computing device 801 is used to implement one or more modules (including instructions implementing the methods illustrated in the methods 300 of FIG. 3, the method 500 of FIG. 5 and the method 600 of FIG. 6), the mass storage memory 716 may include a hard disk drive, an optical drive, a tape storage device, a solid-state memory (e.g., a flash memory, a RAM memory, etc.), a magnetic memory (e.g., a hard drive), or any other memory suitable for mass storage. As used herein, the terms module, block, function, operation, procedure, routine, step, and method refer to tangible computer program logic or tangible computer executable instructions that provide the specified functionality to the computing device 701 and the mobile mapping system 700. Thus, a module, block, function, operation, procedure, routine, step, and method can be implemented in hardware, firmware, and/or software. In one embodiment, program modules and routines (e.g., the mapping module 107, map element module 108, a route module 122, a map element module 124 and an emphasis module 126, etc.) are stored in mass storage memory 716, loaded into system memory 714, and executed by a processor 702 or can be provided from computer program products that are stored in tangible computer-readable storage mediums (e.g. RAM, hard disk, optical/magnetic media, etc.). Mass storage 716 may also include a database 723 storing GPS data, graphics, mapping data, route data, account data, demographic data, and other data for use by the mapping module 107, map element module 108, a route module 122, a map element module 124 and an emphasis module 126 as well as a database interface module through which the mapping module 107, map element module 108, a route module 122, a map element module 124 and an emphasis module 126, etc., may access the GPS data, graphics, etc. received from a mapping data system 112 or other data system.

The peripheral I/O controller 710 performs functions that enable the processor 702 to communicate with peripheral input/output (I/O) devices 722 and 724, a network interface 726, a cellular network transceiver 727, a local network transceiver 728, and a GPS receiver 729 (via the network interface 726) via a peripheral I/O bus 730. The I/O devices 722 and 724 may be any desired type of I/O device such as, for example, a keyboard, a display (e.g., a liquid crystal display (LCD), a cathode ray tube (CRT) display, etc.), a navigation device (e.g., a mouse, a trackball, a capacitive touch pad, a joystick, a touch screen, an eye tracker, a voice recognition module, etc.), etc. The I/O devices 722 and 724 may be used with the mapping module 107, map element module 108, a route module 122, a map element module 124 and an emphasis module 126, etc. to receive GPS data from the GPS receiver 729, send the GPS data to the backend components of the system 100, render, and display maps and user interfaces as described in relation to the figures. A cellular network transceiver 727 may be resident with the local network transceiver 728. The local network transceiver 728 may include support for a Wi-Fi network, Bluetooth, Infrared, or other wireless data transmission protocols. In other embodiments, one element may simultaneously support each of the various wireless protocols employed by the computing device 701. For example, a software-defined radio may be able to support multiple protocols via downloadable instructions.

In operation, the computing device 701 may be able to periodically poll for visible wireless network transmitters (both cellular and local network) on a periodic basis. Such polling may be possible even while normal wireless traffic is being supported on the computing device 701. The network interface 726 may be, for example, an Ethernet device, an asynchronous transfer mode (ATM) device, an 802.11 wireless interface device, a DSL modem, a cable modem, a cellular modem, etc., that enables the system 100 to retrieve mapping data and route data to communicate with another computer system having at least the elements described in relation to the system 100.

While the memory controller 712 and the I/O controller 710 are depicted in FIG. 7 as separate functional blocks within the chipset 708, the functions performed by these blocks may be integrated within a single integrated circuit or may be implemented using two or more separate integrated circuits. The remote computing devices 730 and 732 may communicate with the computing device 701 over a network link 734. For example, the computing device 701 may receive mapping data created by a mapping application executing on a remote computing device 731, 732. In some embodiments, data and or computer readable instructions may be retrieved by the computing device 701 from a cloud computing server 736 via the Internet 738.

Using the systems and procedures described above, the system 100 for alignment of visual indicators on navigational maps and mapping system 700 can retrieve and analyze data from a computing device that indicates a geographic location. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

For example, the system 700 may include but is not limited to any combination of a LAN, a MAN, a WAN, a mobile, a wired or wireless network, a private network, or a virtual private network. Moreover, while only two remote computing devices 731 and 732 are illustrated in FIG. 7 to simplify and clarify the description, it is understood that any number of client computers are supported and can be in communication within the system 700.

Additionally, certain embodiments are described herein as including logic or a number of components, modules, or mechanisms. Modules may constitute either software modules (e.g., code embodied on a machine-readable medium or in a transmission signal, wherein the code is executed by a processor) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The methods 300, 500 and 600 may include one or more function blocks, modules, individual functions or routines in the form of tangible computer-executable instructions that are stored in a non-transitory computer-readable storage medium and executed using a processor of a computing device (e.g., a server, a personal computer, a smart phone, a tablet computer, a head mounted display, a smart watch, a mobile computing device, or other personal computing device, as described herein). The methods 300, 500 and 600 may be included as part of any backend server 116 or client mobile computing device 106 modules of a computing environment for a system 100 for alignment of visual indicators on navigational maps, for example, or as part of a module that is external to such a system. For example, the methods may be part of a the mapping module 107, map element module 108, a route module 122, a map element module 124 and an emphasis module 126, etc. executing within an application on a computing device of a system 100 for alignment of visual indicators on navigational maps. Though the figures may be described with reference to the other figures for ease of explanation, the methods 300, 500 and 600 can be utilized with other objects and user interfaces. Furthermore, although the explanation above describes steps of the methods 300, 500 and 600 being performed by specific devices (such as a computing device 106 and a mapping system server 116), this is done for illustration purposes only. The blocks of the methods 300, 500 and 600 may be performed by one or more devices or other parts of the system 100, such as the computing device 106 and/or mapping server 116.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a cloud computing environment or as a software as a service (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Still further, the figures depict some embodiments of the system 100 for alignment of visual indicators on navigational maps and mapping system 700 in a mapping system for purposes of illustration only. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for the system 100 for alignment of visual indicators on navigational maps. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A computer-implemented method for rearranging map labels corresponding to map elements for display along a route within a digital map, the method comprising:
obtaining map data for generating a digital map of a geographic area at a certain zoom level, including obtaining an indication of a first placement of map labels corresponding to map elements included in the digital map;
receiving a request for a route between an origin and a destination;
repositioning a subset of the map labels corresponding to map elements that intersect the route at at least one point so as to align the subset of the map labels with the route for visual emphasis, wherein the repositioned subset of the map labels corresponds to a second placement in the digital map at the same zoom level; and
transmitting the repositioned subset of the map labels to the client computing device for display on the digital map.

2. The computer-implemented method of claim 1, wherein the route includes a plurality of route segments, each route segment representing a change in orientation for a direction of travel along the route and repositioning the subset of the map labels includes:
repositioning the subset of the map labels along the lengthwise edge of a first route segment of the route.

3. The computer-implemented method of claim 1 wherein repositioning the subset of the map labels includes repositioning the subset of the map labels evenly against a longitudinal axis of the route.

4. (canceled)

5. The computer implemented method of claim 1 further comprising:
receiving a current location of a client device;
determining that one or more map elements that intersect the route fall within a threshold distance to the current location of the client device; and
providing an additional visual emphasis to map labels corresponding to the one or more map elements that intersect the route within the threshold distance to the current location of the client device.

6. The computer implemented method of claim 1, wherein the route data includes two or more data layers to be displayed on the map, further comprising:
determining a plurality of map elements in a first data layer that each intersect the route at one or more points along the route, each of the plurality of map elements having a corresponding visual identifier displayed on the map; and
rendering each map element in the selected layer that intersects the route with an emphasis.

7. A computer-implemented method for rearranging map labels corresponding to map elements for display along a route within a digital map, the method comprising:
obtaining map data for generating a digital map of a geographic area at a certain zoom level, including obtaining an indication of a first placement of map labels corresponding to map elements included in the digital map;
displaying the digital map with the first placement of the map labels, in a first instance;
receiving a request for a route between an origin and a destination;
obtaining route data in response to the request the route data defining the route traversing the geographic area;
displaying the digital map of the geographic area at the same zoom level, in a second instance, with a second placement of the map labels, including:
displaying the route on the digital map, and
repositioning a subset of the map labels corresponding to map elements that intersect the route at one or more points so as to align the subset of the map labels with the route for visual emphasis.

8. The computer-implemented method of claim 7, wherein the route includes a plurality of route segments, each route segment representing a change in orientation for a direction of travel along the route and wherein repositioning the subset of the map labels includes:
repositioning the subset of the map labels along the lengthwise edge of a first route segment of the route.

9. The computer-implemented method of claim 7 wherein repositioning the subset of the map labels includes:
repositioning the subset of the map labels evenly against a longitudinal axis of the route.

10. (canceled)

11. The computer implemented method of claim 7 further comprising:
receiving a current location of a client device;
determining that one or more map elements that intersect the route fall within a threshold distance to the current location of the client device; and
providing an additional visual emphasis to map labels corresponding to the one or more map elements that intersect the route within the threshold distance to the current location of the client device.

12. A computer device for rearranging map labels corresponding to map elements for display along a route within a digital map, the computer device comprising:
one or more processors; and
one or more memories coupled to the one or more processors;
the one or more memories including non-transitory computer executable instructions stored therein that, when executed by the one or more processors, cause the one or more processors to:
obtain map data for generating a digital map of a geographic area at a certain zoom level, including obtaining an indication of a first placement of map labels corresponding to map elements included in the digital map;
display the digital map with the first placement of the map labels, in a first instance;
receive a request for a route between an origin and a destination;
obtain route data in response to the request, the route data defining the route traversing the geographic area;
display the digital map of the geographic area at the same zoom level, in a second instance, with a second placement of the map labels, including:
display the route on the digital map, and
reposition a subset of the map labels corresponding to map elements that intersect the route at one or more points so as to align the subset of the map labels with the route for visual emphasis.

13. The computer device of claim 12, wherein the route includes a plurality of route segments, each route segment representing a change in orientation for a direction of travel along the route and wherein the non-transitory computer executable instructions to cause the one or more processors to reposition the subset of the map labels further includes instructions to cause the one or more processors to:
reposition the subset of the map labels along the lengthwise edge of a first route segment of the route.

14. The computer device of claim 12, wherein the non-transitory computer executable instructions to cause the one or more processors to reposition the subset of the map labels adjacent to the route further includes instructions to cause the one or more processors to:
reposition the subset of the map labels evenly against a longitudinal axis of the route.

15. The computer device of claim 12, further comprising non-transitory computer executable instructions to cause the one or more processors to:
receive a current location of a client device; and
determine that one or more map elements that intersect the route fall within a threshold distance to the current location of the client device; and
provide an additional visual emphasis to map labels corresponding to the one or more map elements that intersect the route within the threshold distance to the current location of the client device.

16. The computer device of claim 12, further comprising non-transitory computer executable instructions to cause the one or more processors to:
determine a plurality of map elements in a first data layer that each intersect the route at one or more points along the route, each of the plurality of map elements having a corresponding visual identifier displayed on the map; and
render each map element in the selected layer that intersects the route with an emphasis.

17. A computer readable storage medium comprising non-transitory computer readable instructions stored thereon for rearranging map labels corresponding to map elements for display along a route within a digital map, the instructions when executed on one or more processors cause the one or more processors to:
obtain map data for generating a digital map of a geographic area at a certain zoom level, including obtaining an indication of a first placement of map labels corresponding to map elements included in the digital map;
display the digital map with the first placement of the map labels, in a first instance:
receive a request for a route between an origin and a destination;
obtain route data in response to the request, the route data defining the route traversing the geographic area;
display the digital map of the geographic area at the same zoom level, in a second instance, with a second placement of the map labels, including:
display the route on the digital map, and
reposition a subset of the map labels corresponding to map elements that intersect the route at one or more points so as to align the subset of the map labels with the route for visual emphasis.

18. The computer readable storage medium of claim 17 wherein the route includes a plurality of route segments, each route segment representing a change in orientation for a direction of travel along the route and wherein the non-transitory computer executable instructions to cause the one or more processors to reposition the subset of the map labels further cause the one or more processors to:
reposition the subset of the map labels along the lengthwise edge of a first route segment of the route.

19. The computer readable storage medium of claim 17, wherein the non-transitory computer executable instructions to cause the one or more processors to reposition the subset of the map labels further cause the one or more processors to:
reposition the subset of the map labels evenly against a longitudinal axis of the route.

20. The computer readable storage medium of claim 17 comprising further instructions stored thereon that cause the one or more processors to:
receive a current location of a client device; and
determine that one or more map elements that intersect the route fall within a threshold distance to the current location of the client device; and
provide an additional visual emphasis to map labels corresponding to the one or more map elements that intersect the route within the threshold distance to the current location of the client device.

21. A computer-implemented method rearranging map labels corresponding to street elements for display along a route within a digital map, the method comprising:
obtaining map data for generating a digital map of a geographic area at a certain zoom level, including obtaining an indication of a first placement of map labels corresponding to street elements included in the digital map;
receiving a request for a route between an origin and a destination;
flagging a subset of the map labels corresponding to the street elements that intersect the route at at least one point, wherein the subset of the map labels have a flexible position within the digital map;
determining one or more reference points corresponding to the route for alignment of the flagged subset of the map labels;
repositioning the flagged subset of the map labels so as to align the flagged subset of the map labels with the one or more reference points for visual emphasis, wherein the repositioned flagged subset corresponds to a second placement in the digital map at the same zoom level; and
transmitting the repositioned flagged subset for display on the digital map on a client computing device.

22. The computer-implemented method of claim 1, wherein repositioning the subset of the map labels further includes:
flagging one or more map labels that have a flexible position within the digital map; and
providing the one or more flagged map labels to the client computing device.

23. The computer-implemented method of claim 7, further comprising:
changing at least one aspect of a visual style corresponding to one or more map labels of the repositioned subset of the map labels.
